(19) United States
(12) Patent Application Publication
(10) Pub. No.: US 2024/0005183 A1
(43) Pub. Date: Jan. 4, 2024

(54) MARGINAL SAMPLE BLOCK RANK MATCHING

(71) Applicant: Microsoft Technology Licensing, LLC, Redmond, WA (US)

(72) Inventors: Bradley Curtis LACKEY, Redmond, WA (US); Andrew John MCGUINNESS, Thornhill (GB)

(73) Assignee: Microsoft Technology Licensing, LLC, Redmond, WA (US)

(21) Appl. No.: 17/810,226

(22) Filed: Jun. 30, 2022

(51) Int. Cl. G06N 7/00; G06N 20/00

(52) U.S. Cl. CPC G06N 7/005; G06N 20/00

(57) ABSTRACT

A computing system including a processor configured to receive a plurality of marginal distribution samples and a copula support sample including a plurality of copula sample points. The processor may divide the copula support sample into copula sample blocks and divide each of the marginal distribution samples into marginal sample blocks. For each of the copula sample blocks, within each copula dimension, the processor may assign a respective copula value rank to each sampled copula value included in that copula sample block. For each of the marginal sample blocks, the processor may sort the sampled marginal values to match an order of the copula value ranks of the corresponding copula sample block. The processor may generate a plurality of joint distribution sample vectors that each include the sampled marginal values located at corresponding positions across the marginal distribution samples. The processor may output the joint distribution sample vectors.

### BACKGROUND

The Iman-Conover method is an algorithm by which sample data may be generated from a set of correlated marginal distributions. The Iman-Conover method may receive, as inputs, samples taken from the marginal distributions and indications of the dependencies between the marginal distributions given through a copula. When sample data is generated using the Iman-Conover method, the sample data values included in the sample data are correlated as specified by the input correlations. Thus, sample data that accurately reflects the dependencies between the marginal distributions may be generated. Sample data generated using the Iman-Conover method is used when performing Monte Carlo simulations in fields such as engineering, insurance, and supply chain management.

### SUMMARY

According to one aspect of the present disclosure, a computing system is provided, including a processor configured to receive a plurality of marginal distribution samples of a respective plurality of marginal distributions. Each marginal distribution sample may include a plurality of sampled marginal values. The processor may be further configured to receive a copula support sample including a plurality of copula sample points of a copula over a plurality of uniform variates whose number equals a number of the plurality of marginal distributions. Each copula sample point may include a plurality of sampled copula values for each of a plurality of copula dimensions. The processor may be further configured to divide the copula support sample into a plurality of copula sample blocks. The processor may be further configured to divide each of the plurality of marginal distribution samples into a plurality of marginal sample blocks respectively associated with the plurality of copula sample blocks. The plurality of copula sample blocks and the plurality of marginal sample blocks may each have a same size. For each of the plurality of copula sample blocks, within each copula dimension, the processor may be further configured to assign a respective copula value rank to each sampled copula value among the sampled copula values included in that copula sample block. For each of the plurality of marginal sample blocks, the processor may be further configured to sort the sampled marginal values included in that marginal sample block to match an order of the copula value ranks of the corresponding copula sample block. The processor may be further configured to generate a plurality of joint distribution sample vectors that each include the sampled marginal values located at corresponding positions across the plurality of marginal distribution samples. The processor may be further configured to output the plurality of joint distribution sample vectors.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically shows an example computing environment at which correlated marginal distributions may be sampled, according to one example embodiment.

FIG. 2 schematically shows a computing system including a processor at which a plurality of joint distribution sample vectors are computed for a plurality of marginal distributions and a copula, according to the example of FIG. 1.

FIG. 3 shows a first data processing flow for an example set of marginal distribution samples and corresponding copula sample points when the conventional Iman-Conover method is used, according to the example of FIG. 1.

FIG. 4 shows a second data processing flow in which the plurality of marginal distribution samples and another plurality of copula sample points are processed according to the Iman-Conover method, according to the example of FIG. 2.

FIG. 5 shows an example of a third data processing flow according to which the processor may be configured to divide the marginal distribution samples into the plurality of marginal sample blocks, according to the example of FIG. 1.

FIG. 6 shows a fourth data processing flow in which a plurality of sorted marginal distribution samples and the plurality of joint distribution sample vectors may be generated, according to the example of FIG. 1.

FIG. 7 shows a fifth data processing flow in which the plurality of marginal distribution samples and another plurality of copula sample points are processed, according to the example of FIG. 6.

FIG. 8 shows the computing system when the processor is configured to compute a sample vector sequence for which an objective function has an estimated minimum value, according to the example of FIG. 1.

FIG. 9 shows an example graphical user interface (GUI) including a plurality of GUI elements at which a user may define properties of the marginal distributions and the copula, according to the example of FIG. 1.

FIG. 10A shows a flowchart of a method via which a plurality of joint distribution sample vectors may be generated at a computing system, according to the example of FIG. 1.

FIG. 10B shows additional steps of the method of FIG. 10A that may be performed in examples in which the plurality of joint distribution sample vectors are output to a sequence generator module.

FIG. 10C shows additional steps of the method that may be performed at the sequence generator module during each of a plurality of iterations in examples in which the steps of FIG. 10B are performed.

FIG. 10D shows additional steps of the method of FIG. 10A that may be performed when dividing a plurality of marginal distribution samples into marginal sample blocks.

FIG. 11 shows a schematic view of an example computing environment in which the computing system of FIG. 2 may be instantiated.

### DETAILED DESCRIPTION

The Iman-Conover method in its conventional form may be inefficient in scenarios in which input data is repeatedly re-sampled over a plurality of iterations. As discussed in further detail below, re-sampling the input data may require a processor to re-rank the sampled values at each iteration, which may require large amounts of processing. Accordingly, the Iman-Conover method may be difficult to use to generate sample data for optimization algorithms or other computing processes that utilize iterative resampling.

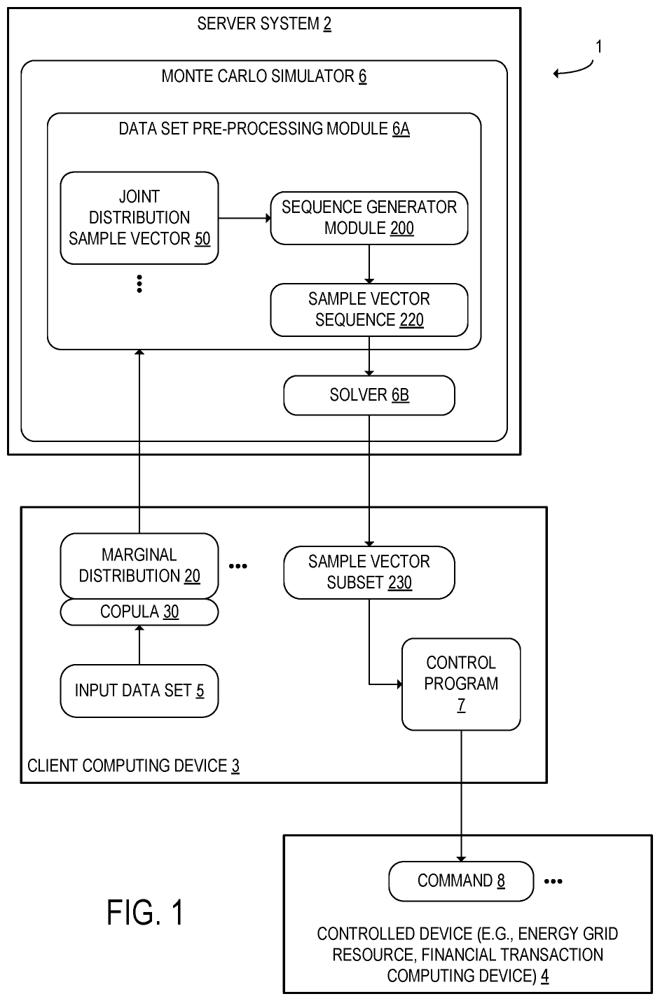

FIG. 1 schematically shows an example computing environment 1 at which correlated marginal distributions may be sampled in a manner that addresses the challenges discussed above. The computing environment 1 of FIG. 1 may include a server system 2, a client computing device 3, and a controlled device 4. At the client computing device 3, a plurality of marginal distributions 20 and a copula 30 may be computed from an input data set 5 and transmitted to the server system 2. A Monte Carlo simulator 6 that includes a data set pre-processing module 6A and a solver 6B may be executed at the server system 2. When the data set pre-processing module 6A is executed, a plurality of joint distribution sample vectors 50 may be computed based at least in part on the plurality of marginal distributions 20 and the copula 30. In addition, the joint distribution sample vectors 50 may be input into a sequence generator module 200 at which the joint distribution sample vectors 50 may be resampled to compute a sample vector sequence 220. At the solver 6B, the sample vector sequence 220 may, for example, be used as an input to a quantum-inspired algorithm at which a sample vector subset 230 of the sample vector sequence 220 is selected.

The server system may transmit the sample vector subset 230 to the client computing device 3. Based at least in part on the sample vector subset 230, the client computing device 3 may generate one or more commands 8 for the controlled device 4 at a control program 7. The controlled device 4 may, for example, be a device that is included in an energy grid and is configured to supply electrical power. As another example, the controlled device 4 may be a financial transaction computing device at which financial transactions may be programmatically performed. As a third example, the controlled device 4 may be an inventory control computing device at which inventory levels and safety stock placements may be determined. The controlled device 4 may be configured to programmatically execute the one or more commands 8 received from the client computing device 3.

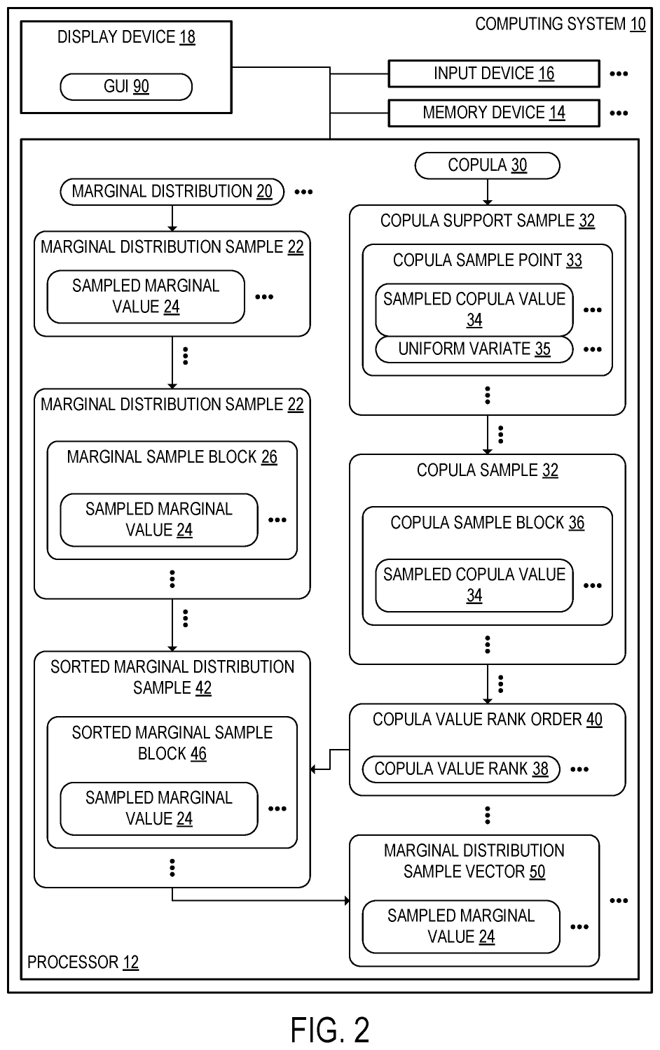

FIG. 2 schematically depicts a computing system 10 that may be included in the example computing environment 1 of FIG. 1. For example, the server system 2 may be instantiated as the computing system 10. The computing system 10 may include a processor 12 configured to execute instructions to perform computing processes. The processor 12 may, in some examples, be instantiated in a plurality of processing devices. For example, the processor 12 may include one or more central processing units (CPUs), graphical processing units (GPUs), field-programmable gate arrays (FPGAs), specialized hardware accelerators, and/or other types of processing devices. The computing system 10 may further include one or more memory devices 14 that are communicatively coupled to the processor 12. The one or more memory devices 14 may, for example, include one or more volatile memory devices and/or one or more non-volatile memory devices.

The computing system 10 may be instantiated in a single physical computing device or in a plurality of communicatively coupled physical computing devices. For example, at least a portion of the computing system 10 may be provided as a server computing device located at a data center. In such examples, the computing system 10 may further include one or more client computing devices configured to communicate with the one or more server computing devices over a network.

The computing system 10 may further include one or more input devices 16 at which a user may enter user input to other components of the computing system 10. The one or more input devices 16 may, for example, include a keyboard, a mouse, a touchscreen, a microphone, an accelerometer, an optical sensor, and/or other types of input devices. In addition, the computing system 10 may further include one or more output devices, which may include a display device 18. One or more other types of output devices, such as a speaker or a haptic feedback device, may additionally or alternatively be included in the computing system 10. The display device 18 may be configured to display a graphical user interface (GUI) 90 at which the user may view outputs of computing processes executed at the processor 12. The user may interact with the GUI 90 via the one or more input devices 16 to provide user input to the computing system 10.

The processor 12 may be configured to receive a plurality of marginal distribution samples 22 of a respective plurality of marginal distributions 20. Each of the plurality of marginal distributions 20 may be a probability distribution or frequency distribution of a dependent variable with respect to an independent variable. Each marginal distribution sample 22 may include a plurality of sampled marginal values 24. In some examples, the processor 12 may be configured to sample the plurality of marginal distribution samples 22 from empirical marginal distribution data. Additionally or alternatively, the processor 12 may be configured to compute the plurality of marginal distribution samples 22 at least in part from a programmatically generated marginal distribution. The plurality of marginal distribution samples 22 may, in some examples, include both sampled marginal values 24 received from empirical marginal distribution data and sampled marginal values 24 computed from one or more programmatically generated marginal distributions.

The processor 12 may be further configured to receive a copula support sample 32 including a plurality of copula sample points 33 of a copula 30. The copula sample points 33 may each be sampled over a plurality of uniform variates 35 whose number equals the number of the plurality of marginal distributions 20. Thus, each copula sample point 33 may have a number of copula dimensions equal to the number of uniform variates 35 and may include a corresponding sampled copula value 34 for each of the uniform variates 35. The processor 12 may be configured to receive a number of sampled copula values 34 equal to the number of sampled marginal values 24.

The copula 30 may encode the dependencies between the plurality of marginal distributions 20, and may, in some examples, be generated based at least in part on empirical correlation data for the plurality of marginal distributions 20. For example, the user may select a family of copula to use for the copula 30, and the parameters of the copula 30 may be generated based at least in part on the empirical correlation data. In other examples, the copula 30 may be programmatically generated. The copula 30 may, for example, be a Gaussian copula, a Clayton copula, a Gumbel copula, a T copula, a vine copula, or an empirical sample copula, and may have a number of dimensions equal to the number of marginal distributions 20. Other types of copulas from the Archimedean or elliptical families may alternatively be used. In some examples, the copula 30 may be a survival copula of one of the types listed above.

In some examples, when at least one of the marginal distributions 20 is programmatically computed, the processor 12 may be configured to compute that marginal distribution 20 based at least in part on the copula 30. Additionally or alternatively, in examples in which the processor 12 is configured to programmatically compute the copula 30, the copula 30 may be computed based at least in part on the plurality of marginal distributions 20.

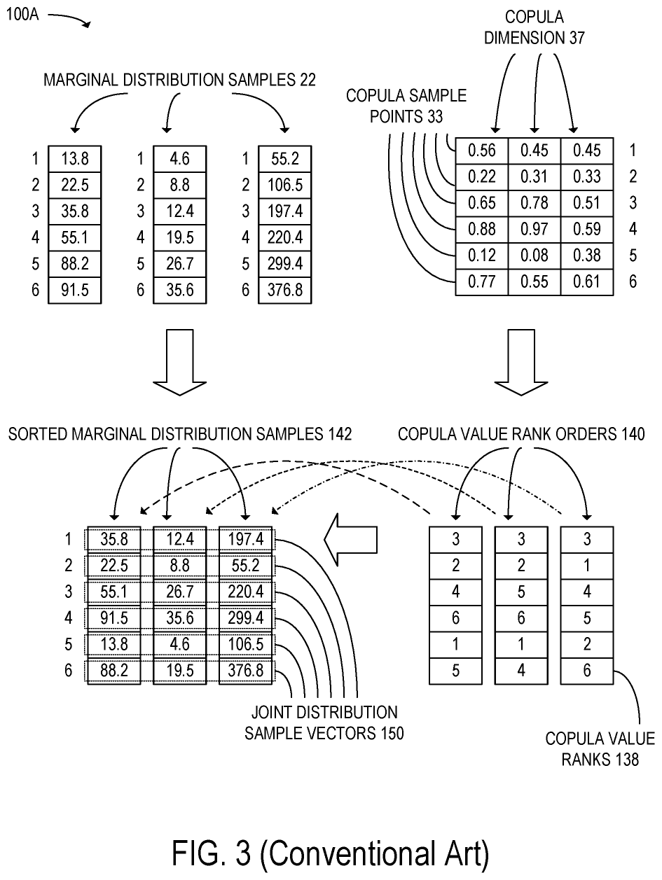

FIG. 3 shows an example of a first data processing flow 100A for an example set of marginal distribution samples 22 and corresponding copula sample points 33 when the conventional Iman-Conover method is used. In the example of FIG. 3, each of the plurality of marginal distribution samples 22 is shown in a form in which the sampled marginal values 24 are sorted in ascending order. The copula sample points 33 in the example of FIG. 3 are unsorted.

Subsequently to receiving the plurality of copula sample points 33, the processor 12 may be further configured to compute a copula value rank order 140 for each of the sampled copula values 34. In each of the copula value rank orders 140, the plurality of sampled copula values 34 are ranked in ascending order with the other sampled copula values 34 that have the same copula dimension 37. The sampled copula values 34 each have a corresponding copula value rank 138 that indicates the position of the sampled copula value 34 in the copula value rank order 140. The copula dimensions 37 are shown as columns in the example of FIG. 3. For clarity, in FIG. 3, the smallest sampled copula value 34 in the first position in the copula value rank order 140 is 0.12, which is found in fifth copula sample point 33. This sampled copula value 34 obtains the copula value rank of 1, which appears in the first copula value rank orders 140 in the fifth position. Alternatively to an ascending order, a descending order could be used for the ranking, so long as the selected order is the same as is used when sorting marginal values.

The processor 12 is further configured to rearrange each of the plurality of marginal distribution samples 22 to generate a respective plurality of sorted marginal distribution samples 142. In each of the plurality of sorted marginal distribution samples 142, the plurality of sampled marginal values 24 are arranged in the copula value rank order 140 of the corresponding copula dimension 37. Thus, the sampled marginal values 24 included in each of the sorted marginal distribution samples 142 may have differing orders corresponding to those of the copula dimensions 37 associated with the sorted marginal distribution samples 142, rather than being arranged in ascending order.

The processor 12 is further configured to generate a plurality of joint distribution sample vectors 150 subsequently to sorting the marginal distribution samples 22 to generate the sorted marginal distribution samples 142. Each of the joint distribution sample vectors 150 includes the sampled marginal values 24 that are located at corresponding positions across the plurality of sorted marginal distribution samples 142. For example, as shown in FIG. 3, the joint distribution sample vectors 150 are shown as rows of a matrix that has the sorted marginal distribution samples 142 as columns. Thus, a joint distribution sample vector 150 is formed from the sampled marginal values 24 located at the beginning of each of the sorted marginal distribution samples 142, and another joint distribution sample vector 150 is formed from the sampled marginal values 24 that are positioned as the second elements of the sorted marginal distribution samples 142. Thus, the joint distribution sample vectors 142 may include corresponding elements associated with each of the copula dimensions 37. Joint distribution sample vectors 150 are generated in this manner for each of the positions in the sorted marginal distribution samples 142. The processor 12 is thereby configured to generate joint distribution sample vectors 150 in which the sampled marginal values 24 have the same rank order as the sampled copula values 34 that have the corresponding copula dimensions 37 in the copula sample points 33. The correlations between the marginal distributions 20, as encoded in the copula 30, are therefore reflected in the plurality of joint distribution sample vectors 150.

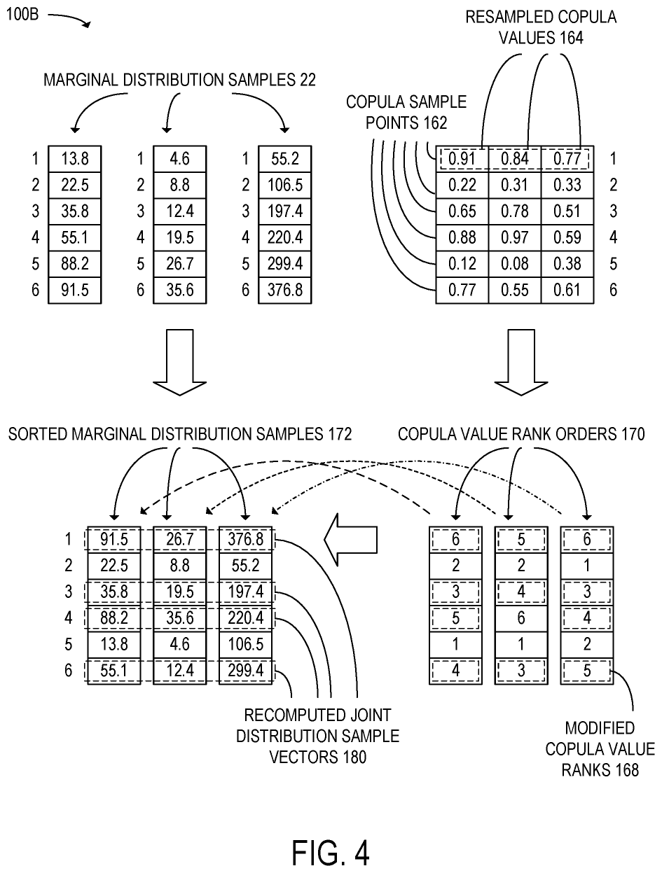

FIG. 4 shows an example of a second data processing flow 100B in which the plurality of marginal distribution samples 22 and another plurality of copula sample points 162 are processed according to the Iman-Conover method. In the example of FIG. 4, the same marginal distribution samples 22 as in the example of FIG. 3 are used. The plurality of copula sample points 162 used in the example of FIG. 4 are identical to the copula sample points 33 of FIG. 3, except the first copula sample point has been modified to include a plurality of resampled copula values 164. As shown in the example of FIG. 4, small changes in the input data may result in large changes in the joint distribution sample vectors that are output when the Iman-Conover method is performed.

The processor 12 is further configured to compute a plurality of copula value rank orders 170 for the plurality of copula samples 162. As shown in the example of FIG. 4, a large proportion of the respective copula value ranks included in the copula value rank orders 170 are modified copula value ranks 168 that differ from the copula value ranks 138 included in the copula value rank orders 140 of FIG. 3. Thus, replacing only one copula sample point 33 in the copula support sample 32 may significantly affect the resulting copula value rank orders 170.

The changes to the copula value rank orders 170 resulting from replacing the sampled copula values 34 with the sampled copula values of the resampled copula values 164 shown in FIG. 4 are further propagated to the sorted marginal distribution samples 172 generated using the copula value rank orders 170. The plurality of joint distribution sample vectors shown in FIG. 4 include a plurality of recomputed joint distribution sample vectors 180 that differ from the joint distribution sample vectors 150 of FIG. 3. The recomputed joint distribution sample vectors 180 form a large proportion of the plurality of joint distribution sample vectors output by the Iman-Conover method in the example of FIG. 4.

Since small numbers of changes to the inputs of the conventional Iman-Conover method may result in large numbers of changes to the outputs, the plurality of joint distribution sample vectors may have to be entirely recomputed whenever one or more marginal distribution samples 22 and/or copula sample points 33 are modified. This re-computation may require large amounts of time and processing.

Returning to the example of FIG. 2, the computing system 10 is shown when a block Iman-Conover method is instead performed at the processor 12 to generate a plurality of joint distribution sample vectors 50. Subsequently to receiving the copula support sample 32, the processor 12 may be further configured to divide the copula support sample 32 into a plurality of copula sample blocks 36. The number of sampled copula values 34 included in each of the copula sample blocks 36 is an exact multiple of a size of the each of the copula sample blocks 36 and may be equal to the size multiplied by the number of copula dimensions 37. In some examples, as discussed in further detail below, the processor 12 may be configured to receive the size of the copula sample blocks 36 via the GUI 90.

The processor 12 may be further configured to divide each of the plurality of marginal distribution samples 22 into a plurality of marginal sample blocks 26 respectively associated with the plurality of copula sample blocks 36. The plurality of copula sample blocks 36 and the plurality of marginal sample blocks 26 may each have the same size. Thus, each copula sample block 36 may be associated with a marginal sample block 26 that includes the same number of sampled marginal values 24 as the number of sampled copula values 34 included in that copula sample block 36.

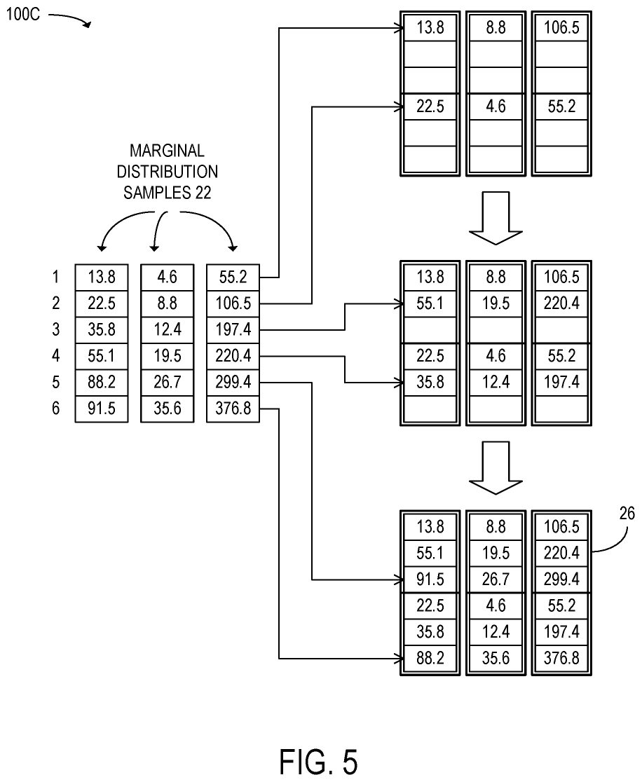

In contrast to generating the plurality of copula sample blocks 36, in which the copula sample points 33 are kept in a fixed order, the processor 12 may be configured to rearrange the sampled marginal values 24 included in the marginal distribution samples 22 when generating the plurality of marginal sample blocks 26. FIG. 5 shows an example of a third data processing flow 100C according to which the processor 12 may be configured to divide the marginal distribution samples 22 into the plurality of marginal sample blocks 26. The third data processing flow 100C may be performed during pre-processing to perform initial allocation of the sampled marginal values 24. Dividing the marginal distribution samples 22 into the plurality of marginal sample blocks 26 may include, for each of the marginal distribution samples 22, reordering the marginal distribution sample 22 into an order of the sampled marginal values 24. The marginal distribution samples 22 are shown in the example of FIG. 5 subsequently to performing this reordering. In the example of FIG. 5, the sampled marginal values 24 are arranged in ascending order. In other examples, the sampled marginal values 24 may be arranged in descending order.

Generating the plurality of marginal sample blocks 26 for a marginal distribution sample 22 may further include iteratively assigning the sampled marginal values 24 to each of the marginal sample blocks 26 of the marginal distribution sample 22. In each iteration, each sampled marginal value 24 assigned to a respective marginal sample block 26 may be a randomly or pseudorandomly selected sampled marginal value 24 selected from a subset of the reordered marginal distribution sample 22. The subset may include a number of consecutive sampled marginal values 24 equal to the number of marginal sample blocks 26. In the example of FIG. 5, for each of the reordered marginal distribution samples 22, the first two sampled marginal values 24 in that marginal distribution sample 22 are assigned to the two marginal sample blocks 26 associated with that marginal distribution sample 22 as the first elements of those marginal sample blocks 26. The processor 12 is configured to randomly or pseudorandomly select which sampled marginal value 24 is assigned to which of the marginal sample blocks 26.

In each of the subsequent iterations, the processor 12 is further configured to assign the next subset of consecutive sampled marginal values 24 to the marginal sample blocks 26. The processor 12 may be configured to iterate through subsets of consecutive sampled marginal values 24 until, for each marginal distribution sample 22, each sampled marginal value 24 included in that marginal distribution sample 22 has been assigned to a respective marginal sample block 26.

The plurality of marginal sample blocks 26 generated according to the third data processing flow 100C of FIG. 5 each include sampled marginal values 24 that are arranged in ascending order. In addition, the ranges of the sampled marginal values 24 included in each of the marginal sample blocks 26 are close to the full ranges of the marginal distribution samples 22 rather than only covering small portions of the full ranges. Accordingly, the joint distribution sample vectors 50 that are computed as discussed in further detail below may have rank correlations that more accurately reflect the dependencies of the copula support sample 32.

Returning to FIG. 2, subsequently to generating the plurality of marginal distribution sample blocks 26, the processor 12 may be further configured to generate a plurality of sorted marginal distribution samples 42. The sorted marginal distribution samples 42 may each include a respective plurality of sorted marginal sample blocks 46. The sorted marginal sample blocks 46 may be generated by sorting the sampled marginal values 24 included in the marginal distribution sample blocks 26 as discussed below. The processor 12 may be further configured to compute the plurality of joint distribution sample vectors 50 from the plurality of sorted marginal distribution samples 42.

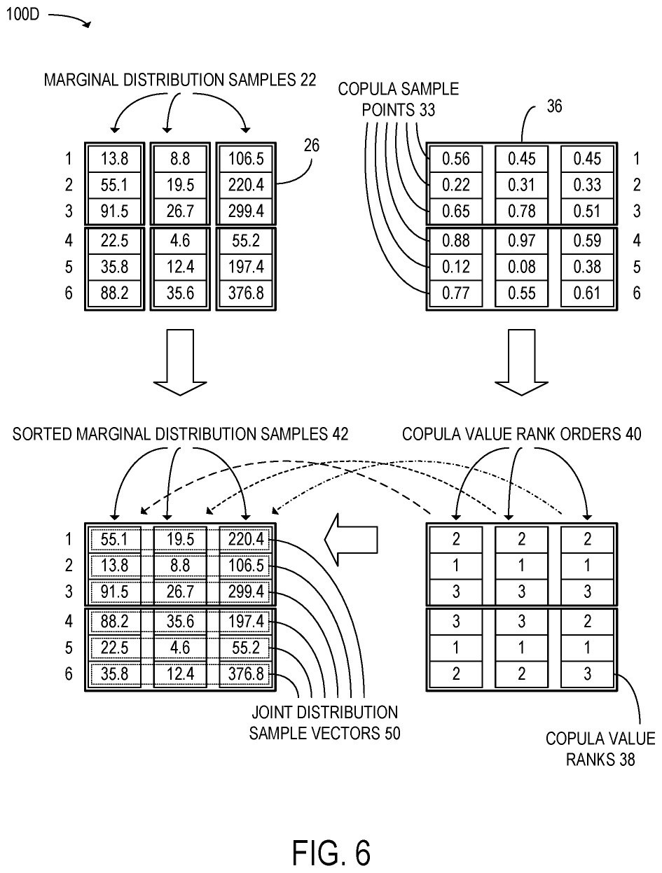

FIG. 6 shows an example of a fourth data processing flow 100D that may occur at the processor 12 when the plurality of sorted marginal distribution samples 42 and the plurality of joint distribution sample vectors 50 are generated. As shown in FIG. 6, for each of the plurality of copula sample blocks 36, within each copula dimension 37, the processor 12 may be further configured to assign a respective copula value rank 38 to each sampled copula value 34 among the sampled copula values 34 included in that copula sample block 36. As in the example of FIG. 3, the copula dimensions 37 are shown as columns in the example of FIG. 6. In the example of FIG. 6, the copula value ranks 38 are assigned to the sampled copula values 34 in ascending order. In other examples, the copula value ranks 38 may be assigned to the sampled copula values 34 in descending order.

For each of the plurality of marginal sample blocks 26, the processor 12 may be further configured to sort the sampled marginal values 24 included in that marginal sample block 26 to match an order of the copula value ranks 38 of the corresponding copula sample block 36. The sampled marginal values 24 in each of the marginal sample blocks 26 may accordingly be sorted to generate sorted marginal sample blocks 46 that reflect the rank ordering between the sampled copula values 34 in the copula sample blocks 36.

The processor 12 may be further configured to generate a plurality of joint distribution sample vectors 50 that each include the sampled marginal values 24 located at corresponding positions across the plurality of sorted marginal distribution samples 42. In FIG. 6, the joint distribution sample vectors 50 are shown as rows of a matrix in which the columns are the sorted marginal distribution samples 42. The processor 12 is thereby configured to generate joint distribution sample vectors 50 in which the sampled marginal values have the rank correlations between the marginal distributions 20 that are encoded in the copula sample blocks 36.

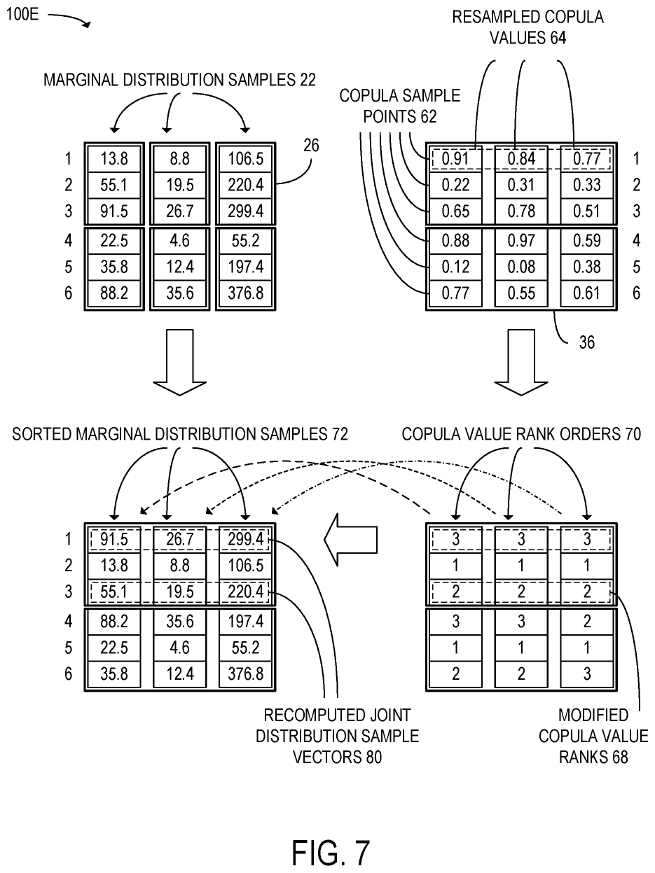

FIG. 7 shows an example of a fifth data processing flow 100E in an example in which the plurality of marginal distribution samples 22 and another plurality of copula sample points 62 are processed. In the example of FIG. 7, the plurality of marginal distribution samples are the same as those of FIG. 6, but the copula sample values 34 in the first copula sample point 62 have been replaced with resampled copula values 64 to generate a plurality of copula sample points 62. For at least one copula sample block 36 of the plurality of copula sample blocks 36, the processor 12 does not replace one or more sampled copula values 34 with one or more respective resampled copula values 64. In the example of FIG. 7, the lower copula sample block 36 is left unchanged.

In the example of FIG. 7, the marginal distribution samples 22 and the copula sample points 62 are shown after the marginal sample blocks 26 and the copula sample blocks 36 have been generated. The processor 12 may be configured to compute a plurality of copula value rank orders 70 for the copula sample points 62 that differ from the copula value rank orders 40 computed for the copula sample points 33 of FIG. 6. As depicted in the example of FIG. 7, when the processor 12 computes a plurality of copula value ranks 38 for the sampled copula values 34, the processor 12 only computes modified copula value ranks 68 relative to the copula value ranks 38 shown in FIG. 6 for the copula sample blocks 36 in which the resampled copula values 64 are located. Therefore, when the processor 12 computes sorted marginal distribution samples 72 based at least in part on the copula value rank orders 70, the order of the sorted marginal distribution samples 72 only differs from the order of the sorted marginal distribution samples 42 in the marginal distribution sample blocks 26 corresponding to the copula sample blocks 36 in which the resampled copula sample values 64 are located. Thus, the sampled marginal values 24 included in at least one marginal sample block 26 are not re-sorted. The at least one marginal sample block 26 that is not re-sorted may correspond to the at least one copula sample block 36 for which resampling is not performed.

In the example of FIG. 7, when a plurality of joint distribution sample vectors 50 are generated from the sorted marginal distribution samples 72, recomputed joint distribution sample vectors 80 are only generated for those corresponding marginal sample blocks 26. The processor 12 may avoid having to recompute the joint distribution sample vectors 50 for the marginal sample blocks 26 associated with copula sample blocks 36 that are not modified when the copula 30 is resampled. The processor 12 may accordingly reduce the amount of computation performed and the amount of time consumed when computing the recomputed joint distribution sample vectors 80.

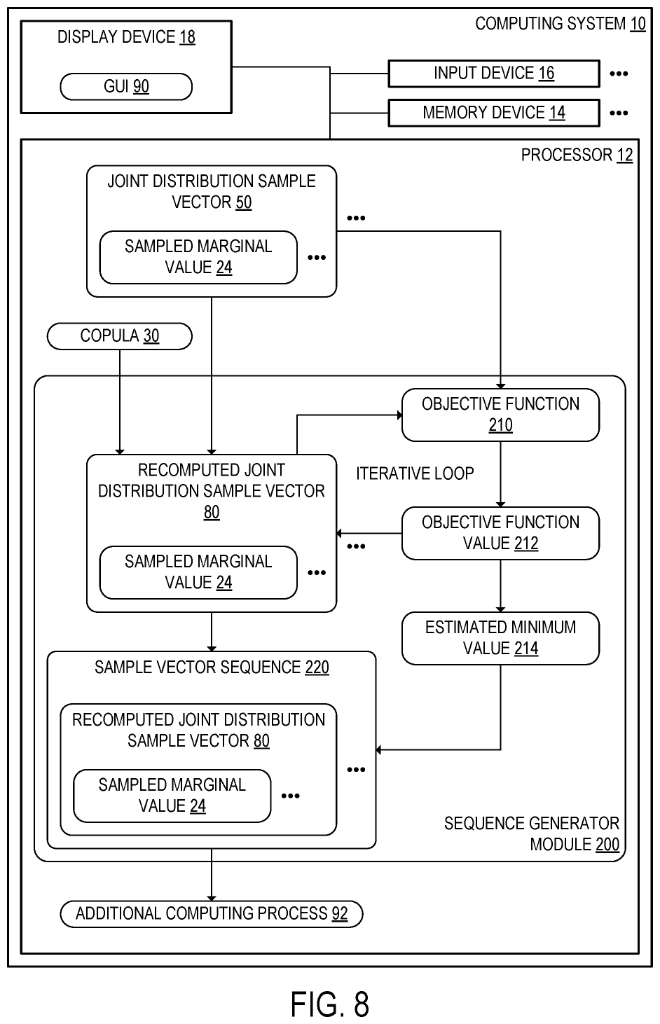

As depicted in the example of FIG. 8, further processing may be performed on the joint distribution sample vectors 50 that includes resampling at least a portion of the input data with which the joint distribution sample vectors 50 are generated. Thus, the savings in processing time when recomputing the joint distribution sample vectors 50 as discussed above may be realized in such examples. FIG. 8 shows the computing system 10 in an example in which the processor 12 is further configured to output the plurality of joint distribution sample vectors 50 to a sequence generator module 200. At the sequence generator module 200, the processor 12 may be further configured to compute an estimated minimum value 214 of an objective function 210 at least in part by iteratively recomputing the plurality of joint distribution sample vectors 50. The objective function 210 may take the joint distribution sample vectors as input. In some examples, as discussed in further detail below, the objective function 210 may be a sample stratification objective function.

Iteratively recomputing the plurality of joint distribution sample vectors may include, in each of a plurality of iterations, computing a value 212 of the objective function 210 based at least in part on the joint distribution sample vectors 50. In each of the iterations, the processor 12 may be further configured to generate a plurality of recomputed joint distribution sample vectors 80 based at least in part on the value 212 of the objective function 210. The recomputed joint distribution sample vectors 80 may then be used as the joint distribution sample vectors with which the value 212 of the objective function 210 is computed in a subsequent iteration. The processor 12 may be further configured to execute an optimization algorithm over the plurality of recomputed joint distribution sample vectors 80 to compute a sample vector sequence 220 including the plurality of joint distribution sample vectors 80 for which the objective function 210 has the estimated minimum value 214.

In one example, the processor 12 may be configured to sample a sample vector sequence 220 of joint distribution sample vectors X⁽¹⁾, . . . , X^{(N)} from a multivariate distribution. The goal in this example may be to compute an aggregate value of the dependent variables of the multivariate distribution and to group the values of the aggregate distribution into a plurality of strata. Although an analytical solution may be computed in the case of some families of distributions, such as a multivariate Gaussian distribution, Monte Carlo techniques may be used in real-world scenarios in which exact distributions are unknown or a solution would be analytically intractable to compute.

The aggregate may be given by:

$$S = {\sum }_{i = 1}^{D} {X}_{i}$$

Since each of the marginal distributions (X₁, . . . , X_{D}) may be a univariate distribution, S may also be a univariate distribution. The CDF of S may be denoted as F₀, and the CDFs of the marginal distributions Xᵢ may be denoted as Fᵢ. The processor 12 may be further configured to compute respective p-values of the aggregate S and the marginal distribution samples as P₀=F₀(S) and Pᵢ=Fᵢ(Xᵢ).

For the sequence of joint distribution sample vectors X⁽¹⁾, . . . , X^{(N)}, the processor 12 may be further configured to compute a respective occupation of each stratum in each of the dimensions 1, . . . , D as well as the aggregate S (which is assigned the index 0). The occupations of the strata may be given by:

$${c}_{j , k} = \vert \{ {P}_{j}^{( t )} : \frac{k - 1}{N} \leq {P}_{j}^{( t )} < \frac{k}{N} \} \vert$$

The occupation of a stratum is the number of marginal distribution samples with p-values in the dimension j that are included in the stratum k. When all the variables are fully stratified, c_{j,k}=1.

The processor 12 may be further configured to compute an objective function value 212 for the aggregate S and the sample vector sequence X⁽¹⁾, . . . , X^{(N)} using the following objective function 210:

$$K = {\sum }_{k = 1}^{N} {w}_{0} \cdot {( {c}_{0 , k} - 1 )}^{2} + {\sum }_{j = 1}^{D} {\sum }_{k = 1}^{N} {w}_{j} \cdot {( {c}_{j , k} - 1 )}^{2}$$

In the above objective function 210, w₀ and wⱼ are adjustable parameters. The first term of K, as shown in the above equation, indicates an extent to which the aggregate S is stratified. The second term of K indicates an extent to which the sample vector sequence X⁽¹⁾, . . . , X^{(N)} is stratified. In this example, setting w₀>>maxᵢ wᵢ may prioritize stratification of the aggregate S over stratification of the sample vector sequence X⁽¹⁾, . . . , X^{(N)}. The processor 12 may be further configured to compute values of the aggregate S and the sample vector sequence X⁽¹⁾, . . . , X^{(N)} for which the objective function K has an estimated minimum value 214. These values of S and X⁽¹⁾, . . . , X^{(N)} may be the output of the sequence generator module 200.

The processor 12 may be further configured to output the sample vector sequence 220 to an additional computing process 92. The additional computing process 92 may, for example, be a complex computation approximated by Monte Carlo simulation or a training data generating process for a machine learning model. In some examples, as shown in FIG. 1, the sample vector sequence 220 may be output to a solver 6B at which the processor 12 may be configured to compute a sample vector subset 230. The sample vector subset 230 may include a subset of the recomputed joint distribution sample vectors 80 included in the sample vector sequence 220, and may, for example, be computed using a quantum-inspired algorithm. The additional computing process 92 may, for example, be the control program 7 shown in FIG. 1. As another example, the sample vector subset 230 may be used as training data when training a machine learning model.

During each of the plurality of iterations performed at the sequence generator module 200, the processor 12 may be configured to compute the recomputed joint distribution sample vectors 80 as follows. For each of the plurality of copula sample points 33, the processor 12 may be configured to receive one or more resampled copula values 64 generated from the copula 30, as shown in the example of FIG. 7. Thus, the processor 12 may be configured to compute the recomputed joint distribution sample vectors 80 with the resampled copula values 64 while leaving the sampled marginal values 24 unchanged. For each of the plurality of copula sample points 33, subsequently to receiving the corresponding resampled copula values 64, the processor 12 may be further configured to replace one or more of the sampled copula values 34 in a copula sample block 36 of the plurality of copula sample blocks 36 with the one or more resampled copula values 64, as depicted in the example of FIG. 7. The processor 12 may be further configured to reassign the plurality of copula value ranks 38 within the copula sample block 36 subsequently to replacing the one or more sampled copula values 34 with the one or more resampled copula values 64. Thus, the plurality of copula values included in the copula sample block 36 may have respective modified copula value ranks 68.

For each of the plurality of marginal distribution samples 22, the processor 12 may be further configured to re-sort the sampled marginal values 24 included in the marginal sample block 26 corresponding to the copula sample block 36 for which the one or more sampled copula values 34 are modified. The sampled marginal values 24 may be re-sorted such that they are arranged in an order of the reassigned copula value ranks 68 in the copula sample blocks 36 that contain resampled copula values 64. As shown in the example of FIG. 7, the processor 12 may be further configured to generate the plurality of recomputed joint distribution sample vectors 80 such that the recomputed joint distribution sample vectors 80 each include the sampled marginal values 24 located at corresponding positions across the sorted marginal distribution samples 72 subsequently to re-sorting the plurality of marginal sample blocks 26. The recomputed joint distribution sample vectors 80 are shown in FIG. 7 as rows of a matrix in which the columns are the sorted marginal distribution samples 72.

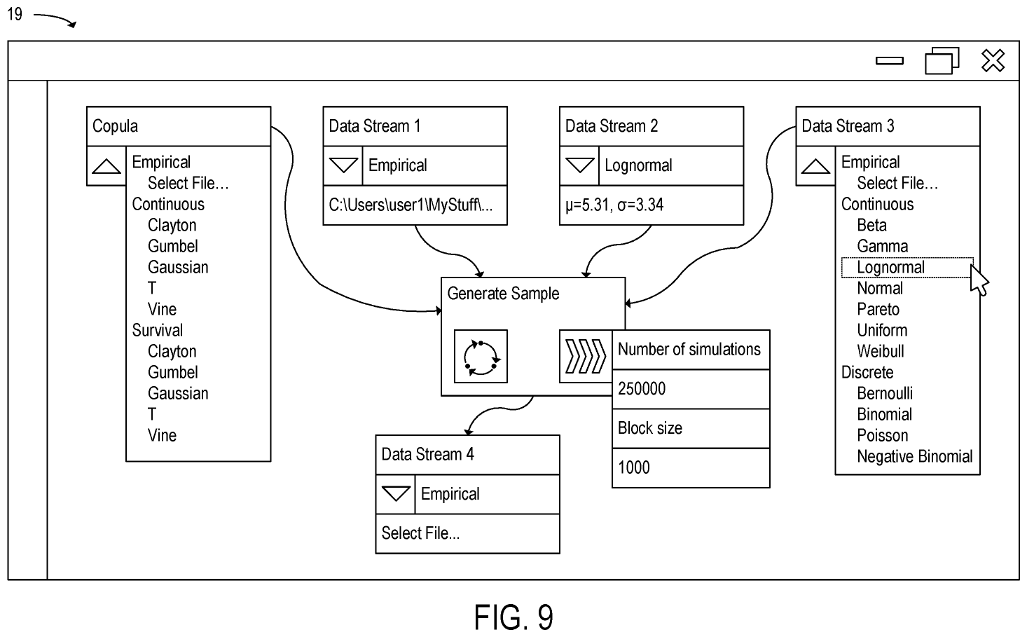

Turning now to FIG. 9, an example of the GUI 19 is shown. The example GUI 19 includes a plurality of GUI elements at which the user may define the properties of the marginal distributions 20 (shown in the GUI 19 as Data Stream 1, Data Stream 2, and Data Stream 3) and the copula 30. In addition, the GUI 19 includes GUI elements at which the processor 12 may be configured to receive the size of the copula sample blocks 36 and the number of joint distribution sample vectors 50 to output. The processor 12 may be further configured to output the joint distribution sample vectors 50 (shown in the GUI 19 as Data Stream 4) to a user-specified file system location. As discussed above with reference to FIG. 8, the plurality of joint distribution sample vectors 50 may include one or more recomputed joint distribution sample vectors 80 that have been recomputed to satisfy an objective function 210 more closely.

In some examples, as shown in the GUI 19 of FIG. 9, the processor 12 may be configured to sample the plurality of marginal distribution samples 22 from empirical marginal distribution data. At the GUI 19, the user may specify a file path to a file system location from which the processor 12 may be configured to load the empirical marginal distribution data. Alternatively, the processor 12 may be configured to synthetically generate at least one of the marginal distributions 20. For example, the marginal distribution 20 may be a beta, gamma, lognormal, normal, Pareto, uniform, Weibull, Bernoulli, binomial, Poisson, or negative binomial distribution.

In some examples, the processor 12 may be further configured to generate the copula 30 based at least in part on empirical correlation data for the plurality of marginal distributions 20. As shown in the example of FIG. 9, the processor 12 may be configured to receive, at the GUI 19, an indication of a file path to a file system location from which the processor 12 may be configured to load the empirical correlation data. In other examples, the processor 12 may be configured to synthetically generate the copula 30. For example, the copula 30 may be generated as a Clayton, Gumbel, Gaussian, T, or vine copula.

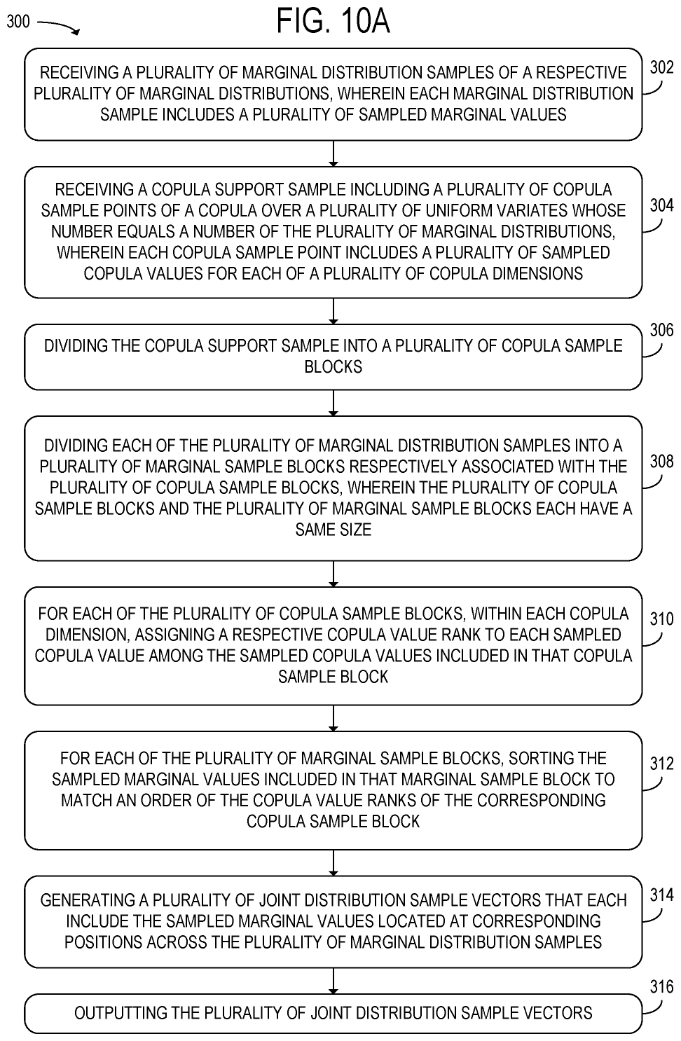

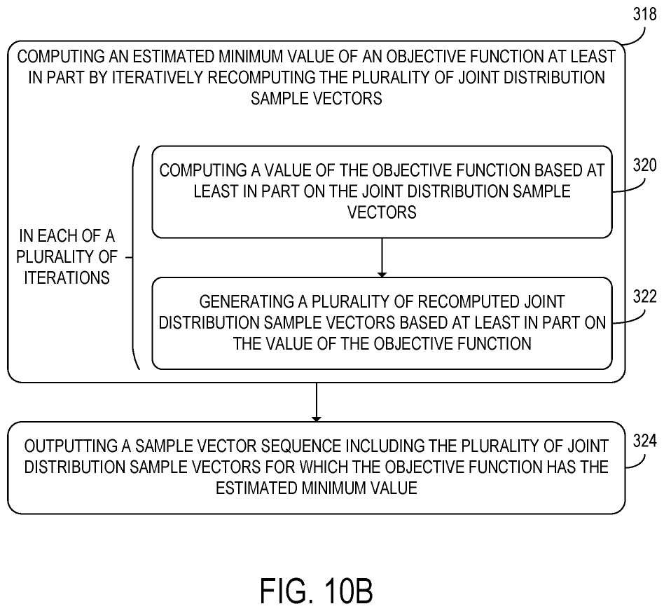

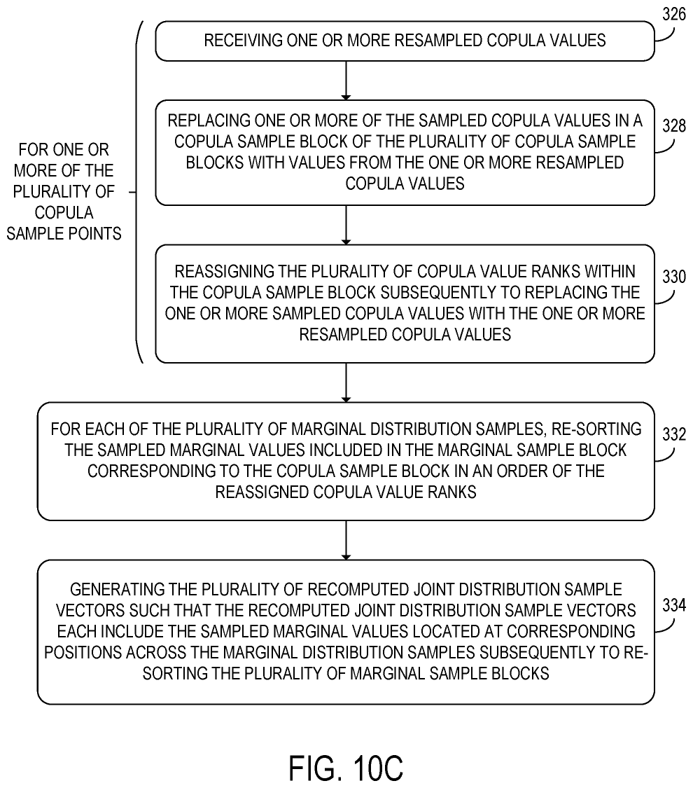

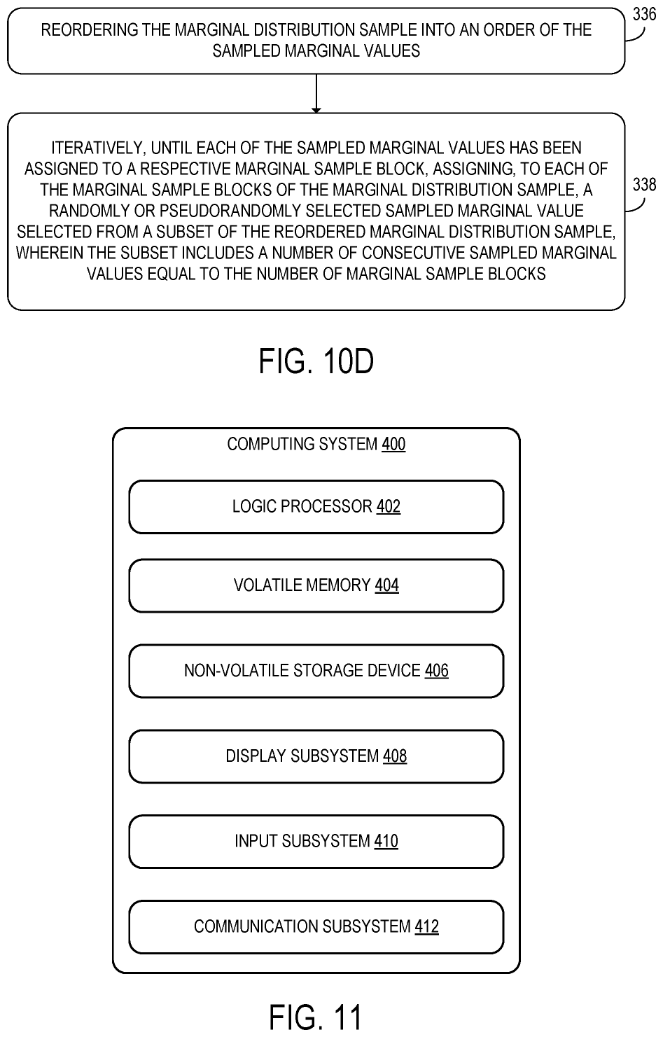

FIG. 10A shows a flowchart of an example method 300 for use with a computing system. Using the method 300 of FIG. 10A, a plurality of joint distribution sample vectors may be generated. The method 300 may include, at step 302, receiving a plurality of marginal distribution samples of a respective plurality of marginal distributions. Each marginal distribution sample may include a plurality of sampled marginal values. In some examples, performing step 302 may include sampling the plurality of marginal distribution samples from empirical marginal distribution data. Additionally or alternatively, performing step 302 may include synthetically generating marginal distribution sample data. Properties of the marginal distributions may be specified by a user at a GUI.

At step 304, the method 300 may further include receiving a copula support sample including a plurality of copula sample points of a copula over a plurality of uniform variates whose number equals a number of the plurality of marginal distributions. Each copula sample point may include a plurality of sampled copula values for each of a plurality of copula dimensions. The number of sampled copula values received at step 304 may be equal to the number of sampled marginal values received at step 302, and the number of copula sample points may be equal to the number of samples in each marginal distribution. In some examples, performing step 304 may include generating the copula based at least in part on empirical correlation data. The copula may, for example, be a Gaussian copula, a Clayton copula, a Gumbel copula, a T copula, a vine copula, or an empirical sample copula. The copula may alternatively be some other type of copula from the Archimedean or elliptical families. In some examples, the copula may be a survival copula of one of the types listed above. Properties of the copula may be specified by a user at the GUI.

At step 306, the method 300 may further include dividing the copula support sample into a respective plurality of copula sample blocks. In addition, at step 308, the method 300 may further include dividing each of the plurality of marginal distribution samples into a plurality of marginal sample blocks respectively associated with the plurality of copula sample blocks. The association between the copula sample blocks and the marginal sample blocks may be one-to-one, and the plurality of copula sample blocks and the plurality of marginal sample blocks may each have a same size. In some examples, performing steps 306 and 308 may include receiving the size of the copula sample blocks via the GUI.

At step 310, the method 300 may further include, for each of the plurality of copula sample blocks, within each copula dimension, assigning a respective copula value rank to each sampled copula value among the sampled copula values included in that copula sample block. The copula value ranks may, in some examples, be assigned to the sampled copula values in ascending order. Alternatively, the copula value ranks may be assigned to the sampled copula values in descending order.

At step 312, the method 300 may further include for each of the plurality of marginal sample blocks, sorting the sampled marginal values included in that marginal sample block to match an order of the copula value ranks of the corresponding copula sample block. Thus, the sampled marginal values may be reordered within the marginal sample blocks to reflect the rank correlations between the sampled copula values included in the corresponding copula sample blocks.

At step 314, the method 300 may further include generating a plurality of joint distribution sample vectors that each include the sampled marginal values located at corresponding positions across the plurality of marginal distribution samples. Since the sampled marginal values have been reordered within the marginal sample blocks, the joint distribution sample vectors include sampled marginal values that are approximately correlated as specified by the copula. At step 316, the method 300 may further include outputting the plurality of joint distribution sample vectors to an additional computing process.

FIG. 10B shows additional steps of the method 300 that may be performed in examples in which the plurality of joint distribution sample vectors are output to a sequence generator module. The sequence generator module may be configured to output a sample vector sequence of joint distribution sample vectors that fulfill one or more additional conditions as well as having the correlations encoded in the copula. At step 318, the method 300 may further include, at the sequence generator module, computing an estimated minimum value of an objective function. The estimated minimum value of the objective function may be computed at least in part by iteratively recomputing the plurality of joint distribution sample vectors. In each of a plurality of iterations, iteratively recomputing the joint distribution sample vectors may include, at step 320, computing a value of the objective function based at least in part on the joint distribution sample vectors. Each of the plurality of iterations may further include, at step 322, generating a plurality of recomputed joint distribution sample vectors based at least in part on the value of the objective function. The method 300 may further include, at step 324, outputting a sample vector sequence including the plurality of joint distribution sample vectors for which the objective function has the estimated minimum value. Accordingly, the joint distribution sample vectors may be iteratively recomputed to obtain a sample vector sequence that fulfills the objective encoded in the objective function.

FIG. 10C shows additional steps of the method 300 that may be performed at the sequence generator module during each of the plurality of iterations in examples in which the steps of FIG. 10B are performed. Steps 326, 328, and 330 may be performed for one or more of the plurality of copula sample points. At step 326, the method 300 may further include receiving one or more resampled copula values. At step 328, the method 300 may further include replacing one or more of the sampled copula values in a copula sample block of the plurality of copula sample blocks with the one or more resampled copula values. In addition, for at least one copula sample block of the plurality of copula sample blocks, one or more sampled copula values are not replaced with one or more respective resampled copula values. Thus, resampling may be performed for sampled copula values included in a subset of the plurality of copula sample blocks. At step 330, the method 300 may further include reassigning the plurality of copula value ranks within the copula sample block subsequently to replacing the one or more sampled copula values with the one or more resampled copula values.

At step 332, for each of the plurality of marginal distribution samples, the method 300 may further include re-sorting the sampled marginal values included in the marginal sample block corresponding to the copula sample block in an order of the reassigned copula value ranks. For at least one marginal sample block corresponding to the at least one copula sample block in which the sampled copula values are not resampled, the plurality of sampled marginal values may not be resampled. Accordingly, rather than re-sorting the entire marginal distribution sample, a subset of the marginal distribution sample blocks may be re-sorted.

At step 334, the method 300 may further include generating the plurality of recomputed joint distribution sample vectors such that the recomputed joint distribution sample vectors each include the sampled marginal values located at corresponding positions across the marginal distribution samples subsequently to re-sorting the plurality of marginal sample blocks. Thus, dividing the copula samples and the marginal distribution samples into copula sample blocks and marginal sample blocks may allow the joint distribution sample vectors to be recomputed more efficiently after sampled copula values have been resampled.

FIG. 10D shows additional steps of the method 300 that may be performed when dividing the marginal distribution samples into the plurality of marginal sample blocks at step 308. The steps of FIG. 10D may be performed for each of the marginal distribution samples. At step 336, the method 300 may further include reordering the marginal distribution sample into an order of the sampled marginal values. The sampled marginal values may be arranged in ascending order or descending order.

At step 338, the method 300 may further include iteratively assigning, to each of the marginal sample blocks of the marginal distribution sample, a randomly or pseudorandomly selected sampled marginal value selected from a subset of the reordered marginal distribution sample. The subset may include a number of consecutive sampled marginal values equal to the number of marginal sample blocks. The sampled marginal values may be assigned to the marginal sample blocks in this manner until each of the sampled marginal values has been assigned to a respective marginal sample block. Thus, the marginal sample blocks may be generated such that the ranges of sampled marginal values in the marginal sample blocks are close to the ranges of sampled marginal values in the entire marginal distribution samples, thereby allowing the correlations between the elements of the joint distribution sample vectors to match the rank correlations of the sampled copula values more accurately.

Using the systems and methods discussed above, joint distribution sample vectors may be generated for a plurality of marginal distributions such that the elements of the joint distribution sample vectors are correlated as specified by a copula. By dividing a copula support sample and marginal distribution samples into copula sample blocks and marginal distribution sample blocks when generating the joint distribution sample vectors, processing time may be saved when the joint distribution sample vectors are recomputed for resampled copula values, in comparison to conventional forms of the Iman-Conover method. These processing time savings allow the systems and methods discussed above to be used to efficiently compute correlated samples of marginal distributions in settings in which the joint distribution sample vectors are iteratively recomputed, such as when the processor solves for an estimated minimum value of an objective function that takes the joint distribution sample vectors as inputs.

In some embodiments, the methods and processes described herein may be tied to a computing system of one or more computing devices. In particular, such methods and processes may be implemented as a computer-application program or service, an application-programming interface (API), a library, and/or other computer-program product.

FIG. 11 schematically shows a non-limiting embodiment of a computing system 400 that can enact one or more of the methods and processes described above. Computing system 400 is shown in simplified form. Computing system 400 may embody the computing system 10 described above and illustrated in FIG. 2. Components of the computing system 400 may be instantiated in one or more personal computers, server computers, tablet computers, home-entertainment computers, network computing devices, video game devices, mobile computing devices, mobile communication devices (e.g., smart phone), and/or other computing devices, and wearable computing devices such as smart wristwatches and head mounted augmented reality devices.

Computing system 400 includes a logic processor 402 volatile memory 404, and a non-volatile storage device 406. Computing system 400 may optionally include a display sub system 408, input sub system 410, communication sub system 412, and/or other components not shown in FIG. 11.

Logic processor 402 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors (hardware) configured to execute software instructions. Additionally or alternatively, the logic processor may include one or more hardware logic circuits or firmware devices configured to execute hardware-implemented logic or firmware instructions. Processors of the logic processor 402 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Volatile memory 404 may include physical devices that include random access memory. Volatile memory 404 is typically utilized by logic processor 402 to temporarily store information during processing of software instructions. It will be appreciated that volatile memory 404 typically does not continue to store instructions when power is cut to the volatile memory 404.

Non-volatile storage device 406 includes one or more physical devices configured to hold instructions executable by the logic processors to implement the methods and processes described herein. When such methods and processes are implemented, the state of non-volatile storage device 406 may be transformed—e.g., to hold different data.

Non-volatile storage device 406 may include physical devices that are removable and/or built in. Non-volatile storage device 406 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 406 may include nonvolatile, dynamic, static, read/write, read-only, sequential-access, location-addressable, file-addressable, and/or content-addressable devices. It will be appreciated that non-volatile storage device 406 is configured to hold instructions even when power is cut to the non-volatile storage device 406.

Aspects of logic processor 402, volatile memory 404, and non-volatile storage device 406 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 400 typically implemented in software by a processor to perform a particular function using portions of volatile memory, which function involves transformative processing that specially configures the processor to perform the function. Thus, a module, program, or engine may be instantiated via logic processor 402 executing instructions held by non-volatile storage device 406, using portions of volatile memory 404. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 408 may be used to present a visual representation of data held by non-volatile storage device 406. The visual representation may take the form of a graphical user interface (GUI). As the herein described methods and processes change the data held by the non-volatile storage device, and thus transform the state of the non-volatile storage device, the state of display subsystem 408 may likewise be transformed to visually represent changes in the underlying data. Display subsystem 408 may include one or more display devices utilizing virtually any type of technology. Such display devices may be combined with logic processor 402, volatile memory 404, and/or non-volatile storage device 406 in a shared enclosure, or such display devices may be peripheral display devices.

When included, input subsystem 410 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included, communication subsystem 412 may be configured to communicatively couple various computing devices described herein with each other, and with other devices. Communication subsystem 412 may include wired and/or wireless communication devices compatible with one or more different communication protocols. As non-limiting examples, the communication subsystem may be configured for communication via a wireless telephone network, or a wired or wireless local- or wide-area network, such as a HDMI over Wi-Fi connection. In some embodiments, the communication subsystem may allow computing system 400 to send and/or receive messages to and/or from other devices via a network such as the Internet.

The following paragraphs discuss several aspects of the present disclosure. According to one aspect of the present disclosure, a computing system is provided, including a processor configured to receive a plurality of marginal distribution samples of a respective plurality of marginal distributions. Each marginal distribution sample may include a plurality of sampled marginal values. The processor may be further configured to receive a copula support sample including a plurality of copula sample points of a copula over a plurality of uniform variates whose number equals a number of the plurality of marginal distributions. Each copula sample point may include a plurality of sampled copula values for each of a plurality of copula dimensions. The processor may be further configured to divide the copula support sample into a plurality of copula sample blocks. The processor may be further configured to divide each of the plurality of marginal distribution samples into a plurality of marginal sample blocks respectively associated with the plurality of copula sample blocks. The plurality of copula sample blocks and the plurality of marginal sample blocks may each have a same size. For each of the plurality of copula sample blocks, within each copula dimension, the processor may be further configured to assign a respective copula value rank to each sampled copula value among the sampled copula values included in that copula sample block. For each of the plurality of marginal sample blocks, the processor may be further configured to sort the sampled marginal values included in that marginal sample block to match an order of the copula value ranks of the corresponding copula sample block. The processor may be further configured to generate a plurality of joint distribution sample vectors that each include the sampled marginal values located at corresponding positions across the plurality of marginal distribution samples. The processor may be further configured to output the plurality of joint distribution sample vectors. A potential technical advantage of such a configuration is that joint distribution sample vectors for a set of marginal distributions with correlations specified by a copula may be generated in a manner that may allow the joint distribution sample vectors to be resampled more efficiently.

According to this aspect, the processor may be configured to output the plurality of joint distribution sample vectors to a sequence generator module. At the sequence generator module, the processor may be further configured to compute an estimated minimum value of an objective function at least in part by iteratively recomputing the plurality of joint distribution sample vectors. Iteratively recomputing the plurality of joint distribution sample vectors may include, in each of a plurality of iterations, computing a value of the objective function based at least in part on the joint distribution sample vectors. Iteratively recomputing the plurality of joint distribution sample vectors may further include, in each of the plurality of iterations, generating a plurality of recomputed joint distribution sample vectors based at least in part on the value of the objective function. At the sequence generator module, the processor may be further configured to output a sample vector sequence including the plurality of joint distribution sample vectors for which the objective function has the estimated minimum value. A potential technical advantage of such a configuration is that the joint distribution sample vectors may be efficiently resampled when computing an estimated solution to a stochastic optimization problem.

According to this aspect, during each of the plurality of iterations performed at the sequence generator module, the processor may be further configured to, for one or more of the plurality of copula sample points, receive one or more resampled copula values. For the one or more copula sample points, the processor may be further configured to replace one or more of the sampled copula values in a copula sample block of the plurality of copula sample blocks with the one or more resampled copula values. For the one or more copula sample points, the processor may be further configured to reassign the plurality of copula value ranks within the copula sample block subsequently to replacing the one or more sampled copula values with the one or more resampled copula values. For each of the plurality of marginal distribution samples, the processor may be further configured to re-sort the sampled marginal values included in the marginal sample block corresponding to the copula sample block in an order of the reassigned copula value ranks. The processor may be further configured to generate the plurality of recomputed joint distribution sample vectors such that the recomputed joint distribution sample vectors each include the sampled marginal values located at corresponding positions across the marginal distribution samples subsequently to re-sorting the plurality of marginal sample blocks. A potential technical advantage of such a configuration is that the joint distribution sample vectors may be recomputed efficiently while preserving the correlations specified by the copula.

According to this aspect, for at least one copula sample block of the plurality of copula sample blocks, the processor may not replace one or more sampled copula values with one or more respective resampled copula values. The sampled marginal values included in at least one marginal sample block corresponding to the at least one copula sample block may not be re-sorted. A potential technical advantage of such a configuration is that computing may be saved by only re-sorting a subset of the plurality of blocks.

According to this aspect, the processor may be configured to divide the marginal distribution samples into the plurality of marginal sample blocks at least in part by, for each of the marginal distribution samples, reordering the marginal distribution sample into an order of the sampled marginal values. Dividing the marginal distribution samples into the plurality of marginal sample blocks may further include iteratively assigning to each of the marginal sample blocks of the marginal distribution sample, until each of the sampled marginal values has been assigned to a respective marginal sample block, a randomly or pseudorandomly selected sampled marginal value selected from a subset of the reordered marginal distribution sample. The subset may include a number of consecutive sampled marginal values equal to the number of marginal sample blocks. A potential technical advantage of such a configuration is that the marginal distribution samples within each of the marginal sample blocks may approximate the marginal distribution as a whole. The marginal distribution samples within the blocks may thereby accurately reflect the correlations specified by the copula.

According to this aspect, the copula value ranks may be assigned to the sampled copula values in ascending or descending order. A potential technical advantage of such a configuration is that the ordering of the sampled copula values may be used to re-rank the sampled marginal values.

According to this aspect, the processor may be further configured to receive the size of the copula sample blocks via a graphical user interface (GUI). A potential technical advantage of such a configuration is that the user may specify a parameter of the process by which the joint distribution sample vectors are generated.

According to this aspect, the processor may be further configured to sample the plurality of marginal distribution samples from empirical marginal distribution data. A potential technical advantage of such a configuration is that the joint distribution sample vectors may be generated to model empirical data.

According to this aspect, the processor may be further configured to generate the copula based at least in part on empirical correlation data for the plurality of marginal distributions. A potential technical advantage of such a configuration is that the joint distribution sample vectors may be generated to model empirical data.

According to this aspect, the copula may be a Gaussian copula, a Clayton copula, a Gumbel copula, a T copula, a vine copula, or an empirical sample copula. A potential technical advantage of such a configuration is that the correlations between the marginal distribution samples may be modeled with a variety of different types of copulas.

According to another aspect of the present disclosure, a method for use with a computing system is provided. The method may include receiving a plurality of marginal distribution samples of a respective plurality of marginal distributions. Each marginal distribution sample may include a plurality of sampled marginal values. The method may further include receiving a copula support sample including a plurality of copula sample points of a copula over a plurality of uniform variates whose number equals a number of the plurality of marginal distributions. Each copula sample point may include a plurality of sampled copula values for each of a plurality of copula dimensions. The method may further include dividing the copula support sample into a plurality of copula sample blocks. The method may further include dividing each of the plurality of marginal distribution samples into a plurality of marginal sample blocks respectively associated with the plurality of copula sample blocks. The plurality of copula sample blocks and the plurality of marginal sample blocks may each have a same size. For each of the plurality of copula sample blocks, within each copula dimension, the method may further include assigning a respective copula value rank to each sampled copula value among the sampled copula values included in that copula sample block. For each of the plurality of marginal sample blocks, the method may further include sorting the sampled marginal values included in that marginal sample block to match an order of the copula value ranks of the corresponding copula sample block. The method may further include generating a plurality of joint distribution sample vectors that each include the sampled marginal values located at corresponding positions across the plurality of marginal distribution samples. The method may further include outputting the plurality of joint distribution sample vectors. A potential technical advantage of such a configuration is that joint distribution sample vectors for a set of marginal distributions with correlations specified by a copula may be generated in a manner that may allow the joint distribution sample vectors to be resampled more efficiently.

According to this aspect, the plurality of joint distribution sample vectors may be output to a sequence generator module. The method may further include, at the sequence generator module, computing an estimated minimum value of an objective function at least in part by iteratively recomputing the plurality of joint distribution sample vectors. Iteratively recomputing the plurality of joint distribution sample vectors may include, in each of a plurality of iterations, computing a value of the objective function based at least in part on the joint distribution sample vectors. Iteratively recomputing the plurality of joint distribution sample vectors may further include, in each of the plurality of iterations, generating a plurality of recomputed joint distribution sample vectors based at least in part on the value of the objective function. The method may further include, at the sequence generator module, outputting a sample vector sequence including the plurality of joint distribution sample vectors for which the objective function has the estimated minimum value. A potential technical advantage of such a configuration is that the joint distribution sample vectors may be efficiently resampled when computing an estimated solution to a stochastic optimization problem.

According to this aspect, the method may further include, during each of the plurality of iterations performed at the sequence generator module, for one or more of the plurality of copula sample points, receiving one or more resampled copula values. The method may further include, for the one or more copula points, replacing one or more of the sampled copula values in a copula sample block of the plurality of copula sample blocks with the one or more resampled copula values. The method may further include, for the one or more copula points, reassigning the plurality of copula value ranks within the copula sample block subsequently to replacing the one or more sampled copula values with the one or more resampled copula values. The method may further include, for each of the plurality of marginal distribution samples, re-sorting the sampled marginal values included in the marginal sample block corresponding to the copula sample block in an order of the reassigned copula value ranks. The method may further include generating the plurality of recomputed joint distribution sample vectors such that the recomputed joint distribution sample vectors each include the sampled marginal values located at corresponding positions across the marginal distribution samples subsequently to re-sorting the plurality of marginal sample blocks. A potential technical advantage of such a configuration is that the joint distribution sample vectors may be recomputed efficiently while preserving the correlations specified by the copula.

According to this aspect, for at least one copula sample block of the plurality of copula sample blocks, one or more sampled copula values may not be replaced with one or more respective resampled copula values. The sampled marginal values included in at least one marginal sample block corresponding to the at least one copula sample block may not be re-sorted. A potential technical advantage of such a configuration is that computing may be saved by only re-sorting a subset of the plurality of blocks.

According to this aspect, the method may further include dividing the marginal distribution samples into the plurality of marginal sample blocks at least in part by, for each of the marginal distribution samples, reordering the marginal distribution sample into an order of the sampled marginal values. The method may further include iteratively assigning to each of the marginal sample blocks of the marginal distribution sample, until each of the sampled marginal values has been assigned to a respective marginal sample block, a randomly or pseudorandomly selected sampled marginal value selected from a subset of the reordered marginal distribution sample. The subset may include a number of consecutive sampled marginal values equal to the number of marginal sample blocks. A potential technical advantage of such a configuration is that the marginal distribution samples within each of the marginal sample blocks may approximate the marginal distribution as a whole. The marginal distribution samples within the blocks may thereby accurately reflect the correlations specified by the copula.

According to this aspect, the copula value ranks may be assigned to the sampled copula values in ascending or descending order. A potential technical advantage of such a configuration is that the ordering of the sampled copula values may be used to re-rank the sampled marginal values.

According to this aspect, the method may further include receiving the size of the copula sample blocks via a graphical user interface (GUI). A potential technical advantage of such a configuration is that the user may specify a parameter of the process by which the joint distribution sample vectors are generated.

According to this aspect, the method may further include sampling the plurality of marginal distribution samples from empirical marginal distribution data. The method may further include generating the copula based at least in part on empirical correlation data for the plurality of marginal distributions. A potential technical advantage of such a configuration is that the joint distribution sample vectors may be generated to model empirical data.

According to this aspect, the copula may be a Gaussian copula, a Clayton copula, a Gumbel copula, a T copula, a vine copula, or an empirical sample copula. A potential technical advantage of such a configuration is that the correlations between the marginal distribution samples may be modeled with a variety of different types of copulas.

According to another aspect of the present disclosure, a computing system is provided, including a processor configured to receive a plurality of marginal distribution samples of a respective plurality of marginal distributions. Each marginal distribution sample may include a plurality of sampled marginal values. The processor may be further configured to receive a copula support sample including a plurality of copula sample points of a copula over a plurality of uniform variates whose number equals a number of the plurality of marginal distributions. Each copula sample point may include a plurality of sampled copula values for each of a plurality of copula dimensions. The processor may be further configured to divide the copula support sample into a plurality of copula sample blocks. The processor may be further configured to divide each of the plurality of marginal distribution samples into a plurality of marginal sample blocks respectively associated with the plurality of copula sample blocks. The plurality of copula sample blocks and the plurality of marginal sample blocks may each have a same size. For each of the plurality of copula sample blocks, within each copula dimension, the processor may be further configured to assign a respective copula value rank to each sampled copula value among the sampled copula values included in that copula sample block. For each of the plurality of marginal sample blocks, the processor may be further configured to sort the sampled marginal values included in that marginal sample block to match an order of the copula value ranks of the corresponding copula sample block. The processor may be further configured to generate a plurality of joint distribution sample vectors that each include the sampled marginal values located at corresponding positions across the plurality of marginal distribution samples. The processor may be further configured to output the plurality of joint distribution sample vectors. For one or more of the plurality of copula sample points, the processor may be further configured to receive one or more resampled copula values. For the one or more copula sample points, the processor may be further configured to replace one or more of the sampled copula values in a copula sample block of the plurality of copula sample blocks with the one or more resampled copula values. For the one or more copula sample points, the processor may be further configured to reassign the plurality of copula value ranks within the copula sample block subsequently to replacing the one or more sampled copula values with the one or more resampled copula values. For each of the plurality of marginal distribution samples, the processor may be further configured to re-sort the sampled marginal values included in the marginal sample block corresponding to the copula sample block in an order of the reassigned copula value ranks. For at least one copula sample block of the plurality of copula sample blocks, the processor may not replace one or more sampled copula values with one or more respective resampled copula values. The sampled marginal values included in at least one marginal sample block corresponding to the at least one copula sample block may not be re-sorted. The processor may be further configured to generate a plurality of recomputed joint distribution sample vectors that each include the sampled marginal values within each copula dimension subsequently to re-sorting the plurality of marginal sample blocks. The processor may be further configured to output the plurality of recomputed joint distribution sample vectors. A potential technical advantage of such a configuration is that joint distribution sample vectors for a set of marginal distributions with correlations specified by a copula may be generated in a manner that may allow the joint distribution sample vectors to be resampled more efficiently.

“And/or” as used herein is defined as the inclusive or v, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system comprising:
a processor configured to:
receive a plurality of marginal distribution samples of a respective plurality of marginal distributions, wherein each marginal distribution sample includes a plurality of sampled marginal values;
receive a copula support sample including a plurality of copula sample points of a copula over a plurality of uniform variates whose number equals a number of the plurality of marginal distributions, wherein each copula sample point includes a plurality of sampled copula values for each of a plurality of copula dimensions;
divide the copula support sample into a plurality of copula sample blocks;
divide each of the plurality of marginal distribution samples into a plurality of marginal sample blocks respectively associated with the plurality of copula sample blocks, wherein the plurality of copula sample blocks and the plurality of marginal sample blocks each have a same size;
for each of the plurality of copula sample blocks, within each copula dimension, assign a respective copula value rank to each sampled copula value among the sampled copula values included in that copula sample block;
for each of the plurality of marginal sample blocks, sort the sampled marginal values included in that marginal sample block to match an order of the copula value ranks of the corresponding copula sample block;
generate a plurality of joint distribution sample vectors that each include the sampled marginal values located at corresponding positions across the plurality of marginal distribution samples; and
output the plurality of joint distribution sample vectors.

2. The computing system of claim 1, wherein:
the processor is configured to output the plurality of joint distribution sample vectors to a sequence generator module; and
at the sequence generator module, the processor is further configured to:
compute an estimated minimum value of an objective function at least in part by iteratively recomputing the plurality of joint distribution sample vectors, wherein iteratively recomputing the plurality of joint distribution sample vectors includes, in each of a plurality of iterations:
computing a value of the objective function based at least in part on the joint distribution sample vectors; and
generating a plurality of recomputed joint distribution sample vectors based at least in part on the value of the objective function; and
output a sample vector sequence including the plurality of joint distribution sample vectors for which the objective function has the estimated minimum value.

3. The computing system of claim 2, wherein, during each of the plurality of iterations performed at the sequence generator module, the processor is further configured to:
for one or more of the plurality of copula sample points:
receive one or more resampled copula values;
replace one or more of the sampled copula values in a copula sample block of the plurality of copula sample blocks with the one or more resampled copula values; and
reassign the plurality of copula value ranks within the copula sample block subsequently to replacing the one or more sampled copula values with the one or more resampled copula values;
for each of the plurality of marginal distribution samples, re-sort the sampled marginal values included in the marginal sample block corresponding to the copula sample block in an order of the reassigned copula value ranks; and
generate the plurality of recomputed joint distribution sample vectors such that the recomputed joint distribution sample vectors each include the sampled marginal values located at corresponding positions across the marginal distribution samples subsequently to re-sorting the plurality of marginal sample blocks.

4. The computing system of claim 3, wherein:
for at least one copula sample block of the plurality of copula sample blocks, the processor does not replace one or more sampled copula values with one or more respective resampled copula values; and
the sampled marginal values included in at least one marginal sample block corresponding to the at least one copula sample block are not re-sorted.

5. The computing system of claim 1, wherein the processor is configured to divide the marginal distribution samples into the plurality of marginal sample blocks at least in part by, for each of the marginal distribution samples:
reordering the marginal distribution sample into an order of the sampled marginal values; and
iteratively, until each of the sampled marginal values has been assigned to a respective marginal sample block:
assigning, to each of the marginal sample blocks of the marginal distribution sample, a randomly or pseudorandomly selected sampled marginal value selected from a subset of the reordered marginal distribution sample, wherein the subset includes a number of consecutive sampled marginal values equal to the number of marginal sample blocks.

6. The computing system of claim 1, wherein the copula value ranks are assigned to the sampled copula values in ascending or descending order.

7. The computing system of claim 1, wherein the processor is further configured to receive the size of the copula sample blocks via a graphical user interface (GUI).

8. The computing system of claim 1, wherein the processor is further configured to sample the plurality of marginal distribution samples from empirical marginal distribution data.

9. The computing system of claim 1, wherein the processor is further configured to generate the copula based at least in part on empirical correlation data for the plurality of marginal distributions.

10. The computing system of claim 1, wherein the copula is a Gaussian copula, a Clayton copula, a Gumbel copula, a T copula, a vine copula, or an empirical sample copula.

11. A method for use with a computing system, the method comprising:
receiving a plurality of marginal distribution samples of a respective plurality of marginal distributions, wherein each marginal distribution sample includes a plurality of sampled marginal values;
receiving a copula support sample including a plurality of copula sample points of a copula over a plurality of uniform variates whose number equals a number of the plurality of marginal distributions, wherein each copula sample point includes a plurality of sampled copula values for each of a plurality of copula dimensions;
dividing the copula support sample into a plurality of copula sample blocks;
dividing each of the plurality of marginal distribution samples into a plurality of marginal sample blocks respectively associated with the plurality of copula sample blocks, wherein the plurality of copula sample blocks and the plurality of marginal sample blocks each have a same size;
for each of the plurality of copula sample blocks, within each copula dimension, assigning a respective copula value rank to each sampled copula value among the sampled copula values included in that copula sample block;
for each of the plurality of marginal sample blocks, sorting the sampled marginal values included in that marginal sample block to match an order of the copula value ranks of the corresponding copula sample block;
generating a plurality of joint distribution sample vectors that each include the sampled marginal values located at corresponding positions across the plurality of marginal distribution samples; and
outputting the plurality of joint distribution sample vectors.

12. The method of claim 11, wherein:
the plurality of joint distribution sample vectors are output to a sequence generator module; and
the method further comprises, at the sequence generator module:
computing an estimated minimum value of an objective function at least in part by iteratively recomputing the plurality of joint distribution sample vectors, wherein iteratively recomputing the plurality of joint distribution sample vectors includes, in each of a plurality of iterations:
computing a value of the objective function based at least in part on the joint distribution sample vectors; and
generating a plurality of recomputed joint distribution sample vectors based at least in part on the value of the objective function; and
outputting a sample vector sequence including the plurality of joint distribution sample vectors for which the objective function has the estimated minimum value.

13. The method of claim 12, further comprising, during each of the plurality of iterations performed at the sequence generator module:
for one or more of the plurality of copula sample points:
receiving one or more resampled copula values;
replacing one or more of the sampled copula values in a copula sample block of the plurality of copula sample blocks with the one or more resampled copula values; and
reassigning the plurality of copula value ranks within the copula sample block subsequently to replacing the one or more sampled copula values with the one or more resampled copula values;
for each of the plurality of marginal distribution samples, re-sorting the sampled marginal values included in the marginal sample block corresponding to the copula sample block in an order of the reassigned copula value ranks; and
generating the plurality of recomputed joint distribution sample vectors such that the recomputed joint distribution sample vectors each include the sampled marginal values located at corresponding positions across the marginal distribution samples subsequently to re-sorting the plurality of marginal sample blocks.

14. The method of claim 13, wherein:
for at least one copula sample block of the plurality of copula sample blocks, one or more sampled copula values are not replaced with one or more respective resampled copula values; and
the sampled marginal values included in at least one marginal sample block corresponding to the at least one copula sample block are not re-sorted.

15. The method of claim 11, further comprising dividing the marginal distribution samples into the plurality of marginal sample blocks at least in part by, for each of the marginal distribution samples:
reordering the marginal distribution sample into an order of the sampled marginal values; and
iteratively, until each of the sampled marginal values has been assigned to a respective marginal sample block:
assigning, to each of the marginal sample blocks of the marginal distribution sample, a randomly or pseudorandomly selected sampled marginal value selected from a subset of the reordered marginal distribution sample, wherein the subset includes a number of consecutive sampled marginal values equal to the number of marginal sample blocks.

16. The method of claim 11, wherein the copula value ranks are assigned to the sampled copula values in ascending or descending order.

17. The method of claim 11, further comprising receiving the size of the copula sample blocks via a graphical user interface (GUI).

18. The method of claim 11, further comprising:
sampling the plurality of marginal distribution samples from empirical marginal distribution data; and
generating the copula based at least in part on empirical correlation data for the plurality of marginal distributions.

19. The method of claim 11, wherein the copula is a Gaussian copula, a Clayton copula, a Gumbel copula, a T copula, a vine copula, or an empirical sample copula.

20. A computing system comprising:
a processor configured to:
receive a plurality of marginal distribution samples of a respective plurality of marginal distributions, wherein each marginal distribution sample includes a plurality of sampled marginal values;
receive a copula support sample including a plurality of copula sample points of a copula over a plurality of uniform variates whose number equals a number of the plurality of marginal distributions, wherein each copula sample point includes a plurality of sampled copula values for each of a plurality of copula dimensions;
divide the copula support sample into a plurality of copula sample blocks;
divide each of the plurality of marginal distribution samples into a plurality of marginal sample blocks respectively associated with the plurality of copula sample blocks, wherein the plurality of copula sample blocks and the plurality of marginal sample blocks each have a same size;
for each of the plurality of copula sample blocks, within each copula dimension, assign a respective copula value rank to each sampled copula value among the sampled copula values included in that copula sample block;
for each of the plurality of marginal sample blocks, sort the sampled marginal values included in that marginal sample block to match an order of the copula value ranks of the corresponding copula sample block;
generate a plurality of joint distribution sample vectors that each include the sampled marginal values located at corresponding positions across the plurality of marginal distribution samples;
output the plurality of joint distribution sample vectors;
for one or more of the plurality of copula sample points:
receive one or more resampled copula values;
replace one or more of the sampled copula values in a copula sample block of the plurality of copula sample blocks with the one or more resampled copula values; and
reassign the plurality of copula value ranks within the copula sample block subsequently to replacing the one or more sampled copula values with the one or more resampled copula values;
for each of the plurality of marginal distribution samples, re-sort the sampled marginal values included in the marginal sample block corresponding to the copula sample block in an order of the reassigned copula value ranks, wherein:
for at least one copula sample block of the plurality of copula sample blocks, the processor does not replace one or more sampled copula values with one or more respective resampled copula values; and
the sampled marginal values included in at least one marginal sample block corresponding to the at least one copula sample block are not re-sorted;
generate a plurality of recomputed joint distribution sample vectors that each include the sampled marginal values within each copula dimension subsequently to re-sorting the plurality of marginal sample blocks; and
output the plurality of recomputed joint distribution sample vectors.
